(19) United States
(12) Patent Application Publication
(10) Pub. No.: US 2004/0133809 A1
(43) Pub. Date: Jul. 8, 2004

(54) Method and system for automatically determining compatible and suitable hardware upgrades for computer hardware

(76) Inventors: Nathaniel H. Dahl, Belle Mead, NJ (US); Franck Delattre, Montreuil (FR); Brian Swingle, Hillsborough, NJ (US); Paul Langtry, Hillsborough, NJ (US)

Correspondence Address: Mr. Walter J. Tencza Jr., Suite 3, 10 Station Place, Metuchen, NJ, 08840, US

(21) Appl. No.: 10/737,445

(22) Filed: Dec. 16, 2003

(51) Int. Cl. H04L 9/00; G06F 11/30

(52) U.S. Cl. 713/201

(57) ABSTRACT

A method is disclosed including collecting data concerning the attributes of a user computer, transmitting the data to a sever computer via the internet, analyzing the data to determine whether the attributes satisfy a set of requirements, and supplying an analysis report to the user computer concerning whether the attributes of the user computer satisfy the set of requirements. The method may further include displaying the analysis report on a computer monitor of the user computer.

### FIELD OF THE INVENTION

This invention relates to techniques for determining whether a computer has sufficient hardware or software for an appropriate task.

### BACKGROUND OF THE INVENTION

It is common in existing online “find upgrades” functions to ask the user to enter in some identifying data pertaining to the user's computer, such as the brand and model, and then a simple database lookup is performed to display whatever information is stored for the associated input data. Examples are the “Memory Configurators” at http://www.crucial.com and http://www.kingston.com. Both of these lack any inspection of the user's hardware, and thus are prone to inaccuracy or user failure, in the (common) case of the user either not knowing the correct make and model number of their computer, or selecting an incorrect system. Also, even if the user gets the make and model correct, because there is no hardware data collected from the user's PC, the data presented to them by the database lookup is not tailored to the user's specific hardware situation. For example, if the user Selects “Dell” (trademarked) as the brand and “Optiplex GX1” (trademarked) as the model, he will be presented with a page of memory modules from which to choose. Although these modules are compatible with the Dell (trademarked) Optiplex GX1 (trademarked), the user still has to choose among the offerings, and therefore has the burden of having to know how much memory is currently installed in their user computer, as well as the type, and the configuration. Since the Dell (trademarked) Optiplex GX1 (trademarked) has three memory slots, and each slot can accept a 32 MB (megabytes), 64 MB, 128 MB, or 256 MB SIMM (SIMM stands for “Single In-line Memory Module”) memory module, in either ECC (ECC stands for “Error Correction Code”) or non-ECC types, the existing size and configuration of the user's computer memory is important to make an accurate recommendation on the specific memory upgrade options that are compatible and suitable. If, for example, the Optiplex GX1 (trademarked) has a total of 256 MB made up of two 128 MB memory modules, and the user desires to upgrade to the maximum of 768 MB, the Crucial “Memory Configurator” can do nothing but present the list of available memory modules, leaving the user to discover for himself what he needs to order.

### SUMMARY OF THE INVENTION

The present invention in one or more embodiments provides a software system that operates over the Internet. The purpose of the invention, in one or more embodiments, is to automatically collect technical hardware (and related software) information about a computer of a given user, transmit that information over the internet to another computer program running on a server, analyze that information using programming logic and database lookups, and return to the user both an analysis of the user's hardware (and related software) plus hardware upgrade recommendations.

In one embodiment, the present invention includes a method comprising the steps of collecting data concerning the attributes of a user computer, transmitting the data to a sever computer via the internet, analyzing the data to determine whether the attributes satisfy a set of requirements, and supplying an analysis report to the user computer concerning whether the attributes of the user computer satisfy the set of requirements. The method may further include displaying the analysis report on a computer monitor of the user computer.

In one embodiment, the present invention includes an apparatus comprising a user computer comprised of a processor, which collects data concerning attributes of the user computer. The processor may transmit the data to an Internet connection. The processor may include a server computer. The server computer may receive data from the Internet connection and may analyze the data to determine whether the attributes satisfy a set of requirements. The sever computer may transmit an analysis report to the Internet connection which indicates whether the attributes satisfy the set of requirements.

The set of requirements, may be, or may be replaced by general hardware or software upgrade recommendations. For example, the server computer may analyze the data concerning the user computer to determine the user computer's attributes and then the server computer may provide hardware and/or software upgrade recommendations that are compatible with user the computer. A “set of requirements” in accordance with the present invention, may include a set of of upgrade possibilities, i.e. see what hardware and/or software upgrades are both compatible and suitable for general upgrading purposes (faster performance, more capacity, etc.

### BRIEF DESCRIPTION OF THE DRAWINGS

FIG. 1 shows a diagram of an apparatus for use in accordance with one or more embodiments of the present invention;

FIG. 2 shows a flow chart of a method for use in accordance with one or more embodiments of the present invention;

FIG. 3A shows a first portion of a screen for a web page for providing a report in accordance with an embodiment of the present invention;

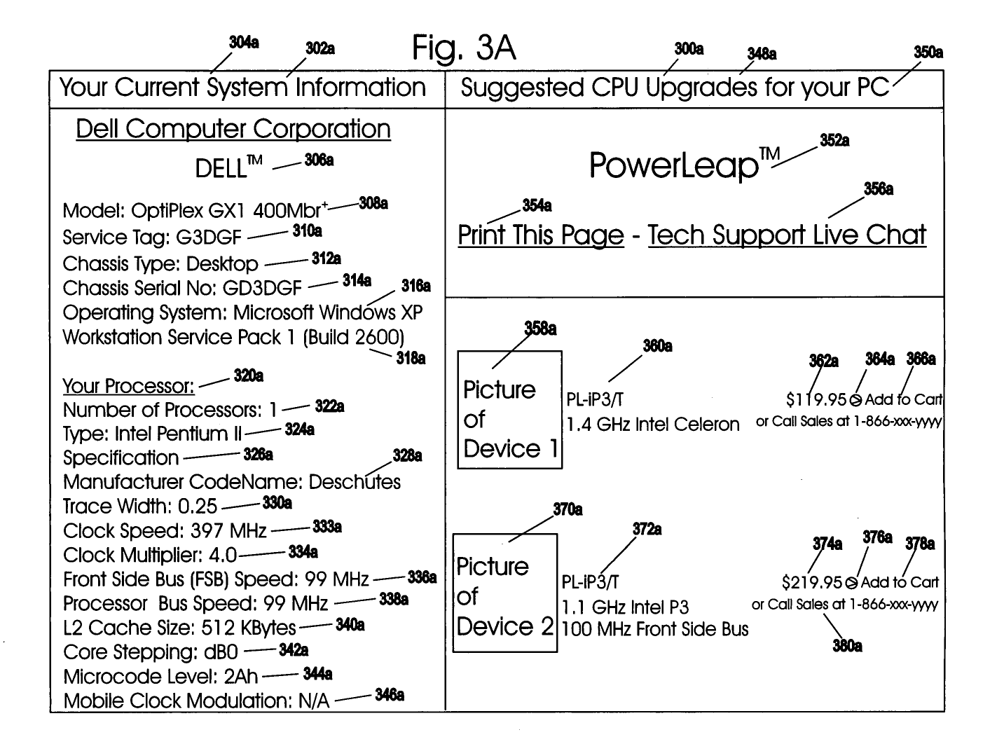

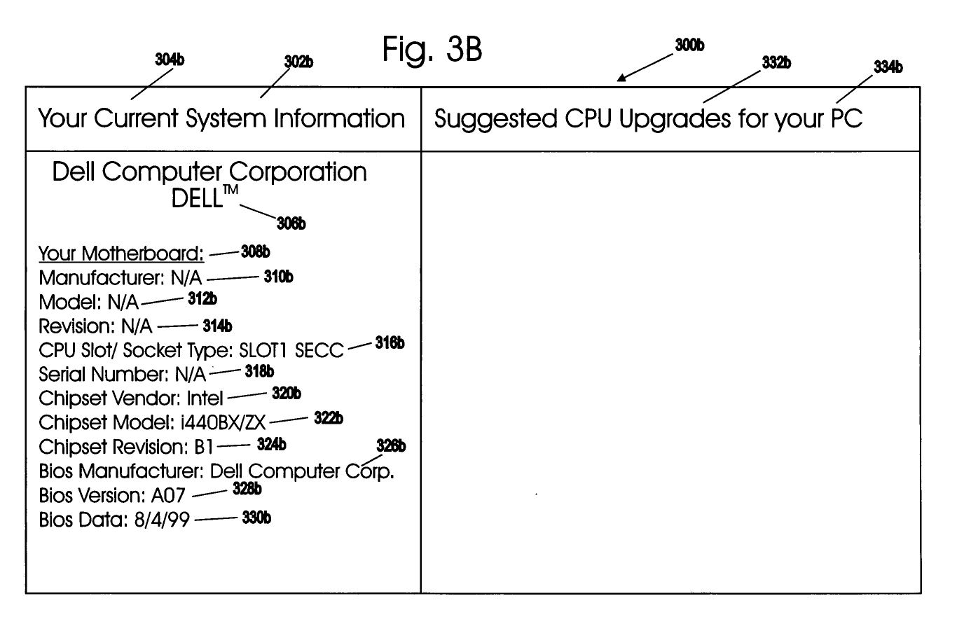

and FIG. 3B shows a second portion of a screen for a web page for providing a report in accordance with an embodiment of the present invention.

### DETAILED DESCRIPTION OF THE DRAWINGS

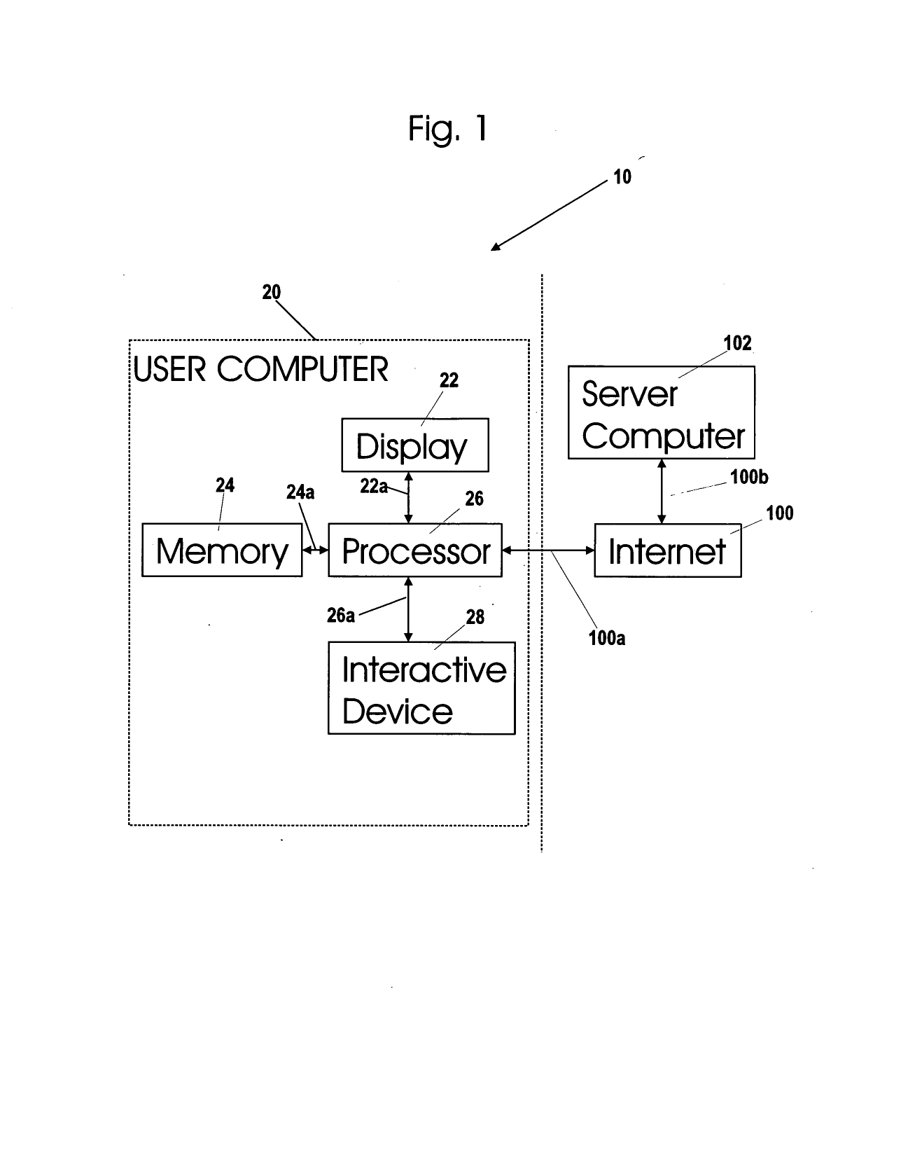

FIG. 1 shows a diagram of an apparatus 10 for use in accordance with one or more embodiments of the present invention. The apparatus 10 includes a user computer 20, and a server computer 102. The user computer 20 may be a computer having a display or monitor 22, a memory 24, a processor 26, and an interactive device 28. The display 22, memory 24, and interactive device 28 may be connected by communications links 22a, 24a, and 28a, respectively, to the processor 26. The communications links 22a, 24a, and 28a may be hardwired, wireless, or any other type of communications links. The interactive device 28 may be comprised of a computer mouse and/or a computer keyboard.

The processor 26 may be connected by communications link 100a to the Internet 100. The server computer 102 may be connected to the Internet 100 by communications link 100b, and thereby connected to the processor 26 and to user computer 20.

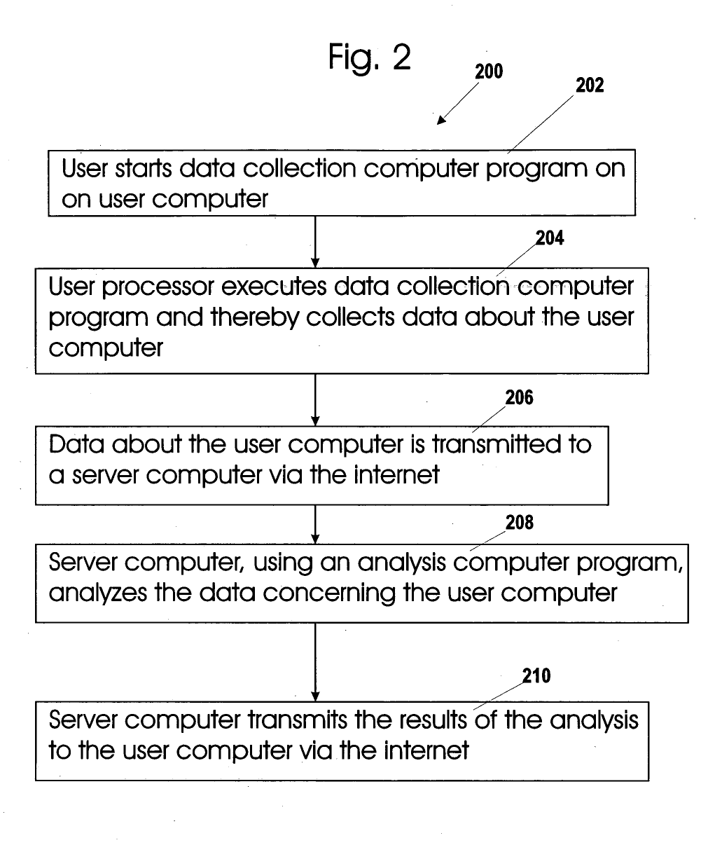

FIG. 2 shows a flow chart 200 of a method for use in accordance with one or more embodiments of the present invention. The method begins at step 200, where a user may start a data collection program on the user computer 20. The data collection program may run on the processor 26 and may be started by clicking on a field or button, of an Internet web page.

At step 204, following the clicking of the start button, the user processor 26 executes the data collection computer program and thereby collects data about the user computer 20. Such data may include, for example, the following data (1) about the user computer 20: (a) Manufacturer, (b) Model, (c) Service Tag and/or Serial Number, (d) Chassis Type, (e) Chassis Serial Number, and (f) Operating System in use. The data may also include data (2) about the processor 26 such as (a) processor type, (b) specification, (c) number of processors installed for processor 26 (d) manufacturer Codename, (e) Trace Width, (f) clock Speed, (g) clock multiplier, (h) front side bus (FSB) (i) processor bus speed, (j) L2 cache size, (k) core stepping, (l) microcode Level, (m) Mobile Clock Modulation/ The data may also include data (3) about a motherboard used for user computer 20 such as (a) manufacturer, (b) model, (c) revision, (d) CPU Slot/Socket Type, (e) serial number, (f) chipset vendor, (g) chipset model, (h) chipset revision, (i) Bios ManufacturerBios Version, (j) Bios Date. The data may include data (4) about a display adapter or video card used for user computer 20 such as (a) manufacturer, (b) model, (c) driver, (d) AGP Version, (e) AGP Data Rate, (f) AGP Aperture Size, (g) AGP SideBand Addressing, and (h) Direct X Revision. The data may also include data (5) about a sound card used for the user computer 20 such as (a) model, and (b) driver.

The data may further include data (6) about system memory such as for memory 24 of user computer 20, which may include (a) memory type, (b) memory installed, (c) memory slots, including total memory slots, memory slots used and memory slots unused, (d) CAS (CAS stands for “Column Address Strobe”) Latency, (e), RAS (RAS stands for “Row Address Strobe”) to CAS Delay, (f) RAS Precharge, (g) Cycle Time, (h) bank cycle time, (i) DRAM (direct random access memory) Idle Time, (j) Total CAS, (k) frequency.

The data may further include data (7) about memory modules for memory 24 of user computer 20, such as (a) memory module type, (b) speed, (c) size, (d) manufacturer, (e) part number, (f) registered, (g) buffered, (h) error correction.

The data may further include data (8) about a logical hard drive(s) for user computer 20, such as (a) logical volume, (b) drive letter, (c) type, (d) size, and (e) percent free.

The data may further include data (9) about a physical hard drive for the user computer 20, such as (a) manufacturer, (b) model, (c) size, (d) interface, (e) ATA (ATA stands for “Advanced Technology Attachment” Version, (f) current data transfer mode, and (g) maximum data transfer mode supported.

The data may include data (10) about one or more compact disc (CD) drives for the user computer 20 such as (a) CD drive, (b) type, (c) manufacturer, (d) model, (e) max read speed, and (f) max write speed.

The data may include data (11) about (a) USB (USB stands for “Universal Serial Bus”) devices installed in user computer 20, (b) USB Interfaces (ports) for user computer 20, (c) PCI BUS Connectors (Slots) for user computer 20, (d) PCI Devices Installed for user computer 20, (e) I/O (input/output) devices available for user computer 20, and (f) I/O (input output) devices in use for user computer 20.

The data may include data (12) about (a) display or monitor 22 brand, (b) display or monitor 22 model, (c) display or monitor 22 specifications, (d) keyboard and mouse specifications, (e) wireless devices installed, (f) network devices installed, (g) PDA devices attached, and (h) device driver versions in use.

At step 206 the data collected is transmitted via communications link 100a, the Internet 100, and communications link 100b, to the server computer 102. At step 208, the server computer 102, using an analysis computer program, analyzes the data received from the user computer 20. At step 210, the server computer 102 transmits the results of the analysis to the user computer 20 via the Internet 100.

The results of the analysis are displayed on the display 22 of the user computer 20 by the processor 26, as a report. An example of a report is shown by FIGS. 3A and 3B. The reports includes portions 300a on FIGS. 3A and 300b on FIG. 3B. The report may be transmitted and displayed as an HTML web page, printed, saved in a variety of electronic file formats, or transmitted via email.

FIG. 3A includes a column 302a which has a title 304a which is indicated to be “Your Current System Information”. The data shown under the title 304a in column 302a is an example of data concerning the attributes of the user computer 20. The data shown in column 302a includes the manufacturer and/or brand name 306a of the user computer 20, which in this case is “DELL™” The data in column 302a also includes the model, service tag, chassis type, chassis serial no., operating system, and workstation service pack 1 data for the user computer 20 in fields 308a, 310a, 312a, 314a, 316a, and 318a. Each item of data is preceded by or includes a heading for what the data is, followed by the actual data, such as the heading “Model” and then the actual model name “OptiPlex GX1 400 MBr”. The data in column 302a also includes data about the processor 26 under the title 320a. The data about the processor 26 includes number of processors within within the processor 26, the type of processor used, the specification, manufacturer code name, trace width, clock speed, clock multiplier, front side bus (FSB) speed, processor bus speed, L2 cache size, core stepping, microcode level, and mobile clock modulation, in fields 322a, 324a, 326a, 328a, 330a, 332a, 334a, 336a, 338a, 340a, 342a, 344a, and 346a. Each item of data is preceded by or includes a heading for what the data is, followed by the actual data, such as the heading “Number of Processors” followed by the number “1”. FIG. 3A also shows a column 348a with a title 350a for “Suggested CPU Upgrades for your PC”. The data in column 348a includes a name of a company that provides the sevice in field 352a, a field 354a to click on to the print the page including portion 300a and 300b, and a field 356a to click on to contact tech support.

The data in column 348a also includes suggested devices for purchase to upgrade the user computer 20. The suggestions in column 348a may include a picture of a “device 1” in field 358a and a written description of the “device 1” in field 360a. The data in column 348a also includes a price for the device 1 in field 362a, a button 364a to click on to add the “device 1” to a shopping cart (to purchase and/or order the “device 1”), a description of “add to cart” in field 366a and a description of “or call sales at 1-866-xxx-yyyy” in field 368a.

The suggestions in column 348a may include a picture of a “device 2” in field 370a and a written description of the “device 2” in field 372a. The data in column 348a also includes a price for the “device 2” in field 374a, a button 376a to click on to add the “device 2” to a shopping cart (to purchase and/or order the “device 2”), a description of “add to cart” in field 378a and a description of “or call sales at 1-866-xxx-yyyy” in field 380a.

FIG. 3B shows further data regarding the user computer 20 in column 302b under heading 304b for “Your Current System information”. The data may include the manufacturer name field 306b. The data may include data about a motherboard used for the user computer 20 and/or the processor 26. The data about the motherboard, which is identified by heading 308b, may include manufacturer, model, revision, CPU Slot/Socket Type: SLOT1 SECC, Serial Number, Chipset Vendor, Chipset Model, Chipset Revision, Bios Manufacturer, Bios Version, and Bios Data in fields 310b, 312b, 314b, 316b, 318b, 320b, 322b, 324b, 326b, 328b, and 330b, respectively. Each of the items of data may be preceded by or include a heading.

FIG. 3B has a colum 332b with a heading 334b. However, there are no further suggestions for changes to the user computer 20, shown in FIG. 3B.

The user computer 20 may be, for example, a Dell (trademarked) Dimension (trademarked) 8100 computer. The data collected by the user computer 20 may pertain to both the hardware and software being used by the user computer 20. The report provided by the server computer 102 and displayed on the display 22 may include some or all of the information gathered previously along with an analysis report that makes upgrade recommendations to the user.

The purpose is to not only to automatically (that is, without user input) gather accurate technical information about the user computer 20 and interpret it for the user in a way intelligible to the average computer user, but also to give the user options for upgrading the user computer 20 to increase its performance, increase its capacity, and/or add functionality.

In another embodiment of the present invention the user computer 20 is analyzed to see if it meets certain specifications in order to be compatible or suitable with a desired hardware or software upgrade or addition. For example, if an embodiment of the present invention were in use by a publisher of computer-based games, the visitor could have their hardware (and related software) environment analyzed to determine if they have sufficient hardware (and related software) resources to run a given game. Or, if a user is interested in a new monitor or display to replace display 22, the present invention in one or more embodiments can be used to determine whether or not the user computer 20 has the correct video modes and refresh rates required to support (or take full advantage of the features of) the desired new display or monitor.

In another example, the manufacturer or reseller of digital cameras or printers could use the present invention in one or more embodiments to help it's prospective customers determine if they have the correct interface installed in their user computer 20 in order to connect to the particular camera or printer. In cases where there is a deficiency, the server 102 can additionally make upgrade recommendations to the user, and display these on display 22 so as to bring the user computer 20 into compliance with a given specification required by the desired camera or printer (or other peripheral device).

An additional embodiment of the present invention would be to analyze a user's computer, such as user computer 20, to see if it meets certain hardware or software specifications in order to be compatible or suitable with a desired upgrade. For example, if a user wishes to purchase a new video card that requires an AGP (AGP stands for “Accelerated Graphics Port”) slot on a motherboard, and a minimum version of DirectX (trademarked) (computer software), the invention can analyze the user's computer, such as computer 20, and instruct the user, by sending a message from server computer 102 to the computer 20, and causing it to be displayed on display 22, whether or not an AGP interface is available, and/or whether or not the correct or appropriate version of DirectX (trademarked) (software) is installed. In the case of discrepancies, the server computer 102 can suggest alternative products, such as video cards that use a PCI (PCI stands for “Personal Computer Interconnect”) slot rather than an AGP slot, and also give the user information and/or a direct link to enable them to download or obtain by other means the correct or appropriate version of DirectX (trademarked). There may be other commercial uses for the invention not outlined here.

The following entities may be some of the target customers for one or more embodiments of the present invention: (1) Consumers—to find upgrades for their computers with a high-level of certainty that what is suggested will be compatible and appropriate for their computer; (2) Manufacturers, distributors, and retailers of computer hardware—to “qualify” their sales to consumers, by using one or more embodiments of the present invention to first analyze the prospective customer's computer to determine whether or not the product that the consumer wants to purchase is compatible or appropriate based on the hardware (and related software) configuration/specification of the prospective customer's computer, or to give the prospective customer a list of suggested or appropriate product choices based on the hardware (and related software) configuration/specification of the prospective customer's computer; (3) Publishers and retailers of computer software—to “qualify” their sales to consumers, by using the invention to first analyze the prospective customer's computer to determine whether or not the software that the consumer wants to purchase is compatible or appropriate based on the hardware (and related software) configuration/specification of the prospective customer's computer, or to give the prospective customer a list of suggested or appropriate product choices based on the hardware (and related software) configuration/specification of the prospective customer's computer; and (4) asset managers and/or IT (information technology) managers to help make appropriate and compatible hardware and software upgrade, expansion, enhancement, etc. decisions based on the analysis of the hardware (and related software) configuration of the computers in their organization.

The present invention, in one more embodiments can make a detailed analysis of a user computer, which typically cannot be done or is difficult to do by a typical user. For example, the analysis of the user computer would reveal, not only how much memory, memory 24 has, but also what kind of memory makes up memory 24. For example, in one embodiment of the present invention analysis of the user computer 20 could reveal that not only is there 256 MB (megabytes) of memory in memory 24 but also that the memory 24 is made up of two 128 MB (megabytes) of SIMM modules (as opposed to a single 256 MB SIMM module). This can be helpful to know that, for example, in order to reach a total of 768 MB, the user would have to remove the two 128 MB SIMM modules and replace them with two 256 MB SIMM modules, plus add an additional 256 MB SIMM module to install into, for example, a previously unused memory slot, for a total of 768 MB.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
collecting data concerning the attributes of a user computer;
transmitting the data to a sever computer via the Internet;
analyzing the data to determine whether the attributes satisfy a set of requirements; and
supplying an analysis report to the user computer concerning whether the attributes of the user computer satisfy the set of requirements.

2. The method of claim 1 further comprising
displaying the analysis report on a computer monitor of the user computer.

3. A method comprising
analyzing data concerning the attributes of a user computer to determine whether the attributes satisfy a set of requirements; and
supplying an analysis report to an Internet connection concerning whether the attributes of the user computer satisfy the set of requirements.

4. The method of claim 3 further comprising
supplying the analysis report to the user computer.

5. The method of claim 4 further comprising
displaying the analysis report on a computer monitor of the user computer.

6. An apparatus comprising:
a user computer comprised of a processor which collects data concerning attributes of the user computer; and
and wherein the processor transmits the data to an Internet connection.

7. The apparatus of claim 6 further comprising
a server computer; and
wherein the server computer receives the data from the Internet connection and analyzes the data to determine whether the attributes satisfy a set of requirements; and
wherein the server computer transmits an analysis report to the Internet connection, which indicates whether the attributes satisfy the set of requirements.

8. The apparatus of claim 7 wherein
the user computer is further comprised of a computer monitor; and
wherein the processor of the user computer causes the analysis report to be displayed on the computer monitor.

9. An apparatus comprising
a server computer;
wherein the server computer receives data from a Internet connection;
wherein the data concerns attributes of a user computer;
and wherein the server computer analyzes the data to determine whether the user computer has attributes which satisfy a set of requirements; and
wherein the server computer transmits an analysis report to the Internet connection, which indicates whether the attributes of the user computer satisfy the set of requirements.

10. A method comprising:
collecting data concerning the attributes of a user computer;
transmitting the data to a sever computer via the Internet;
analyzing the data to determine how the user computer needs to be modified to upgrade the attributes of the user computer; and
supplying an analysis report to the user computer concerning how the user computer needs to be modified to upgrade the attributes of the user computer.
